(19) United States
(12) Patent Application Publication
(10) Pub. No.: US 2006/0023345 A1
(43) Pub. Date: Feb. 2, 2006

(54) Tape guide assembly and tape cartridge format

(76) Inventor: Hugo W. Maule, Chepstow (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/119,508

(22) Filed: Apr. 29, 2005

(30) Foreign Application Priority Data
Apr. 30, 2004 (GB) 0409669.9

(51) Int. Cl. G11B 5/027

(52) U.S. Cl. 360/85

(57) ABSTRACT

A tape guide assembly for a rotary scan tape drive supporting multiple size tape cartridges is disclosed. The tape guide assembly includes a plurality of tape guides. During deployment of tape from a tape cartridge, all of the tape guides move to respective deployed positions. During the movement, only a subset of the tape guides engage with tape, the subset varying in dependence on the size of the tape cartridge. Other systems and methods are also provided.

### CLAIM TO PRIORITY

This application claims priority to United Kingdom utility application entitled, “Tape Guide Assembly and Tape Cartridge Format,” having serial number GB 0409669.9, filed Apr. 30, 2004, which is entirely incorporated herein by reference.

### TECHNICAL FIELD

The present disclosure relates to a tape deployment system for deploying magnetic tape from multiple size tape cartridges around a drum of a rotary scan data transfer apparatus, and to a tape cartridge format.

### BACKGROUND

Magnetic tape is commonly used for storage of digital data. The digital data is accessed by a data transfer apparatus, which can perform one or both of storing (writing) data onto the tape, or accessing (reading) data previously stored on the tape. A generic term for magnetic tape date transfer apparatus is a “tape drive.” A tape drive normally includes a tape head for one or both of reading and/or writing data from or to the magnetic tape. The tape head itself includes one or more tape head elements, which can perform one or both of these functions.

One type of head used in tape drives is a rotary scan head (also known as a helical scan head). Typically, the rotary scan head is in the form of a drum 80. As shown in FIG. 1, the drum 80 typically has one or more head elements 90 positioned on its cylindrical surface for performing read and/or write operations. During a loading process of a tape cartridge that holds a tape for use by the tape drive, a portion of the tape 100 is deployed around the drum 80. During reading and/or writing, the tape 100 is moved in a direction A whilst the drum 80 rotates about an axis B. The drum 80 typically rotates much faster than the speed of movement of the tape 100 so that tracks 101 can be read from, or written to, the tape 100 by the head element 90.

Tape drives using a rotary scan head typically include one or more tape guides in the form of a tape guide assembly. An example tape cartridge 110 and guide assembly 10 for a tape drive is shown in FIGS. 2 and 2a. The tape guide assembly 10 is used to deploy the tape 100 from within the tape cartridge 110 so that at least a portion of the tape is threaded around at least part of the drum 80. The tape guide assembly 10 is also used during reading and/or writing to direct, align and support the tape 100 as it is moved across the drum 80. The tape guides can either be fixed or stationary guides, such as spindles, or moving guides, such as rollers which roll with the tape as the tape moves across the tape head. The tape guides help to align the tape 100 with respect to the drum 80 and may also include flanges 45, 50 to prevent excess lateral movement of the tape. The tape guides can include powered rollers to assist in transport of the tape across the drum, and to provide proper tensioning of the tape.

The guide assermbly 10 shown in FIGS. 2 and 2a includes tape guides in the form of a capstan 30, a pinch roller 20, a number of guide posts 40, 50 and a number of inclined posts 60, 70. The guide posts 40, 50 and pinch roller 20 engage the tape 100 within a tape cartridge 110 or other carrier during a loading process. During a deployment process, the guide posts 40, 50 and pinch roller 20 are moved from their respective start, or non-deployed, positions (shown in FIG. 2) into engagement with the tape 100 and along predetermined guide travel paths to respective finish, or deployed, positions (as shown in FIG. 2a). In this manner, a portion of the tape 100 is extracted from the tape cartridge 110 and is deployed around the drum 80. In its deployed position, the tape 100 is sandwiched by the capstan 30 and the pinch roller 20.

Flanges 45, 55 are typically provided on the top and bottom of the guide posts 40, 50 respectively to restrict lateral movement of the tape 100 with respect to the drum 80. The inclined post 60 is positioned so as to incline the tape with respect to drum 80 when threading onto the drum 80 and the inclined post 70 is positioned to return the tape 100 to the non-inclined position when threading off of the drum 80.

Rotary scan tape drives are designed to use a predetermined size and type of tape cartridge that contains a predetermined length of a predetermined width tape. In this manner, the designer of the tape drive knows the size of the cartridge and the width (w) of tape that must be accommodated and can therefore dimension and position the tape guides and flanges appropriately. The width (w) of the tape typically corresponds to the height (h) of the tape guides so that the tape is aligned with respect to the drum 80 and its head element(s) 90 by the flanges 45, 55 of the guides.

One format for data storage using a rotary scan tape drive is Digital Data Storage (DDS). Various versions of DDS exist and although each version uses the same (approximately 4 mm) width tape in the same Digital Audio Tape (DAT) cartridges, increasingly advanced reading and writing techniques have been used in later versions to achieve greater data storage capacity from the same media as earlier versions. Customers are demanding more and more data storage capacity and in the past, the use of such advanced reading and writing techniques have addressed (at least to some extent) those demands. However, for practical purposes the storage capacity of a given size of tape is ultimately limited by the available surface area of the tape.

Thus, a heretofore unaddressed need exists in the industry to address the aforementioned deficiencies and inadequacies.

### SUMMARY

Embodiments of the present disclosure provide systems for deploying magnetic tape from multiple size cartridges. Briefly described, in architecture, one embodiment of the system, among others, can be implemented as follows. A tape deployment system for deploying magnetic tape from multiple size tape cartridges around a drum of a rotary scan data transfer apparatus includes a tape guide assembly having a plurality of tape guides. Each size tape cartridge of the multiple size tape cartridges hold a magnetic tape having a width different to the width of other sized tapes of said multiple size tape cartridges. Each guide is movable during a tape deployment process between a respective non-deployed position and a respective deployed position. The tape guides are arranged such that during the tape deployment process all move from their non-deployed to their deployed position.

The system further includes a tape cartridge positioning arrangement arranged to locate each size of tape cartridge of the multiple size tape cartridges in a predetermined position relative to the non-deployed position of the plurality of tape guides, such that during the deployment process, when all of the plurality of tape guides move from their non-deployed position to their deployed position, a predetermined subset of the plurality of tape guides engages the magnetic tape of the cartridge. The tape guides of the predetermined subset have heights not substantially greater than the width of the magnetic tape of the respective tape cartridge.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Embodiments of the present disclosure will now be described in detail by way of example only with reference to the accompanying drawings, in which:

FIG. 1 is a schematic diagram of a prior art arrangement showing a portion of a tape deployed around a rotary scan head;

FIG. 2 is a schematic diagram of a prior art tape cartridge and guide assembly for a tape drive prior to deploying tape from the tape cartridge;

FIG. 2a is a schematic diagram of the assembly of FIG. 2 showing the tape cartridge and guide assembly when the tape is deployed;

FIG. 3 is a schematic diagram of a selected elements of a tape drive including a tape guide assembly of one embodiment of the present disclosure;

FIG. 4 is a schematic diagram of a tape cartridge having a tape of a first width inserted into the tape drive of FIG. 3;

FIG. 5 is the schematic diagram of FIG. 4 with the tape deployed around a rotary scan head;

FIG. 6 is a schematic diagram of a tape cartridge having a tape of a second width inserted into the tape drive of FIG. 3;

FIG. 7 is the schematic diagram of FIG. 6 with the tape deployed around a rotary scan head;

FIG. 8 is a schematic diagram of a tape guide assembly of one embodiment of the present disclosure;

FIG. 9 is the schematic diagram of FIG. 8 with a tape cartridge having a tape of a first width deployed around a rotary scan head;

FIG. 10 is the schematic diagram of FIG. 8 with a tape cartridge having a tape of a second width deployed around a rotary scan head;

FIG. 11 is a perspective view of an example guide module suitable for use in the tape guide assembly of FIGS. 8 to 10;

FIG. 12a shows the example guide module in use deploying a magnetic tape having a first width;

FIG. 12b shows the example guide module in use deploying a magnetic tape having a width narrower than the first width;

FIG. 13a shows a modification of the example guide module of FIG. 11 in use deploying a magnetic tape having a first width;

FIG. 13b shows the example guide module of FIG. 13a in use deploying a magnetic tape having a width narrower than the first width;

FIG. 13c is a plan view of the example guide module of FIG. 13a; and

FIG. 14 is a schematic diagram of a tape drive for use with embodiments of the present disclosure arranged to accept a number of different tape widths.

### DETAILED DESCRIPTION

Various embodiments of the present disclosure include a tape deployment system for deploying magnetic tape from multiple size tape cartridges around a drum of a rotary scan data transfer apparatus. Each size tape cartridge of the multiple size tape cartridges holds a magnetic tape having a width different to the width of the other sized tapes of the multiple size tape cartridges. The tape deployment system includes a tape guide assembly having a plurality of tape guides. Each tape guide is movable during a tape deployment process between a respective non-deployed position and a respective deployed position, and the tape guides are arranged such that during the tape deployment process, all move from their non-deployed to their deployed position.

The tape deployment system further includes a tape cartridge positioning arrangement arranged to locate each size of tape cartridge of the multiple size tape cartridges in a predetermined position relative to the non-deployed position of the plurality of tape guides. During a the deployment process, when all of the plurality of tape guides move from their non-deployed position to their deployed position, a predetermined subset of the plurality of tape guides engages the magnetic tape of the cartridge. The tape guides of the predetermined subset have heights not substantially greater than the width of the magnetic tape of the respective tape cartridge.

Various embodiments also include a tape deployment system for deploying magnetic tape from multiple size tape cartridges around a drum of a rotary scan data transfer apparatus. Each size tape cartridge of the multiple size tape cartridges holds a magnetic tape having a width different to the width of the magnetic tapes of the other size cartridges of the multiple size tape cartridges. One embodiment of the system includes a tape deployment means for deploying the different width tapes from the multiple size tape cartridges. The tape deployment means having a plurality of tape guide means each having a height, a non-deployed position, and a deployed position and being arranged such that all move from their non-deployed position to their deployed position during a tape deployment process. The system further includes tape cartridge positioning means for positioning each of the multiple size tape cartridges in a predetermined position with respect to the tape guide means. When all of the tape guide means move from their non-deployed position to their deployed position during the deployment process, only a predetermined subset of the tape guide means from a plurality of subsets of tape guide means defined by the plurality of tape guide means engages the tape. Each subset of tape guide means includes at least one tape guide having a height substantially corresponding to the width of the magnetic tape of the respective magnetic cartridge.

Various embodiments also include a tape deployment system for deploying magnetic tape from a first sized magnetic tape cartridge and a second sized tape cartridge around a drum of a rotary scan data transfer apparatus. The first sized magnetic tape cartridge has a length and a width defining a first footprint and holds a magnetic tape having a first width. The second sized tape cartridge has a length and a width defining a second footprint smaller than the first footprint and holds a magnetic tape with a second width which is less than the first width. The magnetic tape also has a drum engaging the outer side and a non-engaging inner side. The tape deployment system includes a tape guide assembly including a plurality of tape guides positioned for selectively engaging the inner side of the magnetic tapes. The plurality of tape guides include first tape guides with a height substantially greater than the second width and second tape guides with a height not substantially greater than the second width. The first and second tape guides are movable between a respective non-deployed position and a respective deployed position and the first and second tape guides are arranged such that during a tape deployment process all move from their non-deployed position to their deployed position.

One embodiment of the system further includes a tape cartridge positioning structure that defines a first predetermined location to which the first sized cartridges can be inserted and a second predetermined location to which the second sized cartridges can be inserted. The first predetermined location being located, such that when a first sized tape cartridge is located at the first predetermined location with the first and second tape guides in their respective non-deployed positions, the first tape guides are within the first footprint facing the inner side of the first width tape. The second predetermined location is located, such that when a second sized tape cartridge is located at the second predetermined location with the first and second tape guides in their respective non-deployed positions, the first tape guides are disposed externally of the second footprint facing the outer side of the second width tape and the second tape guides are within the second footprint facing the inner side of the second width tape.

Various embodiments also include a tape cartridge format for use in a rotary scan data transfer apparatus with a plurality of tape guides for deploying and supporting tape for reading and/or writing by the data transfer apparatus. The format includes a plurality of tape cartridge sizes. The cartridge size holding a predetermined length of tape of a predetermined width different to the width of tape of the other size cartridges. The tape cartridge of one of the plurality of sizes is locatable in a different predetermined position in the tape drive with respect to respective non-deployed positions of the tape guides, such that during deployment and support of the tape, only a subset of the tape guides corresponding to the width of the tape of that tape cartridge size engage with the tape held by the tape cartridge.

Irrespective of the tape cartridge size or tape width used, all the movable tape guides of the tape deployment system are moved to their deployed positions during a tape deployment process, in some embodiments. However, due to the controlled initial positioning of the tape cartridge in the tape drive, only a subset of the moving tape guides engage the tape. The dimensions of the subsets of guides are selected to suit the respective tape widths. Therefore, as the subset of tape guides move to their deployed positions, the tape will be engaged by appropriately dimensioned guides and be deployed along an appropriate path to ensure the correct amount of tape is deployed around the drum.

Advantageously, due to the movement of all of the movable tape guides in various embodiments, no sensing of tape cartridge type or tape width-is needed. In addition, as the tape guides only engage with their designated tape types, no repositioning of the tape guides' predetermined non-deployed (start) or deployed (finish) positions is needed. Thus, each tape guide always moves along a predetermined path from the same start position to the same finish position, regardless of the size of the tape cartridge. This facilitates simpler and cheaper implementation.

Various embodiments of the present disclosure provide a tape deployment system for a rotary scan tape drive that is capable of deploying and supporting tape from multiple size tape cartridges having respective different widths of tape for reading/writing by the drive's rotary scan head. By providing a guide assembly that can be used for threading tape from different sizes of tape cartridge having different widths of tape, larger tape cartridges and wider tapes can be used, providing a greater surface area for storing data and thus greater storage capacity. At the same time, by allowing wider tapes (for example approximately 6 mm, 8 mm and/or 10 mm width tapes) to be used, some embodiments of the tape deployment system are arranged such that existing tape widths (typically of approximately 4 mm widths) can also be used, meaning that the new tape drive would be compatible with legacy media.

Various embodiments of the present disclosure include an assembly for deploying and supporting tape from multiple size tape cartridges in a rotary scan data transfer apparatus. The assembly includes a plurality of tape guides moveable along respective tape guide paths to respective deployed positions. For all tape cartridge sizes, all of the tape guides are arranged to move to their deployed position, where at least one of the tape guides is arranged to engage with tape from the respective cartridge, during movement to the deployed positions to thereby deploy the tape, in some embodiments.

Various embodiments of the present disclosure also include a tape deployment system for deploying magnetic tape from multiple sizes of tape cartridge around a drum of a rotary scan data transfer apparatus. The system includes tape deployment means for deploying tape from the tape cartridges and tape cartridge positioning means for positioning each of the multiple tape cartridge sizes in a predetermined position with respect to the tape deployment means. The tape deployment means are disposed so that, for each of the multiple tape cartridge sizes, during deployment of the tape, all of the tape deployment means are moved from non-deployed positions to deployed positions and at least a predetermined part or parts of the tape deployment means engage the tape.

Some embodiments include a tape guide assembly for a magnetic rotary scan tape drive supporting multiple size tape cartridges. The assembly includes a plurality of tape guides selected from the set comprising: a guide post, an inclined post, a pinch roller and a capstan. During deployment of tape from a tape cartridge, all of the tape guides are arranged to move to respective deployed positions, where during the movement, only a subset of the tape guides engage with tape. The subset varies in dependence on the size of the tape cartridge and has a height substantially corresponding to at least to the width of the respective tape.

Various embodiments of the present disclosure also include a tape guide assembly for a magnetic rotary scan tape drive supporting multiple size tape cartridges. Each size tape cartridge holds tape of a different width. The assembly further includes a plurality of tape guides selected from at least one of: a guide post, an inclined post, a pinch roller and a capstan, upon deploying tape from a tape cartridge all of the tape guides are arranged to move to respective deployed positions, wherein during the movement only a subset of the tape guides engage with tape, the subset having a height substantially corresponding to at least to the width of the respective tape.

Embodiments of the invention include a rotary scan tape drive supporting multiple size tape cartridges, each size tape cartridge holding tape of a different width, the tape drive including a tape guide assembly and a tape cartridge positioning arrangement, the tape guide assembly including a plurality of tape guides having deployed and non-deployed positions within the tape drive and being selected from at least one of a guide post, an inclined post, a pinch roller, and a capstan. The tape cartridge positioning arrangement is operative to locate each of the multiple size tape cartridges in a predetermined position in the tape drive, where the tape guides are disposed in the tape drive in dependence on the predetermined positions of the tape cartridges. During a deployment process, all of the tape guides move from their respective non-deployed positions to their respective deployed positions, where during the movement, only a subset of the tape guides engage with the tape. The subset varies in dependence on the size of the respective tape cartridge and has a height substantially corresponding to at least to the width of the respective tape.

Some embodiments include a tape cartridge format for use in a rotary scan data transfer apparatus having a plurality of tape guides for deploying and supporting tape for reading and/or writing by the data transfer apparatus. The format includes a plurality of tape cartridge sizes. Each cartridge size holds a predetermined length of tape of a predetermined width, and each tape cartridge of one of the plurality of sizes is locatable in a different predetermined position in the tape drive with respect to the tape guides, such that during deployment and support of the tape, only a subset of the tape guides corresponding to the tape cartridge size engage with the tape held by the tape cartridge.

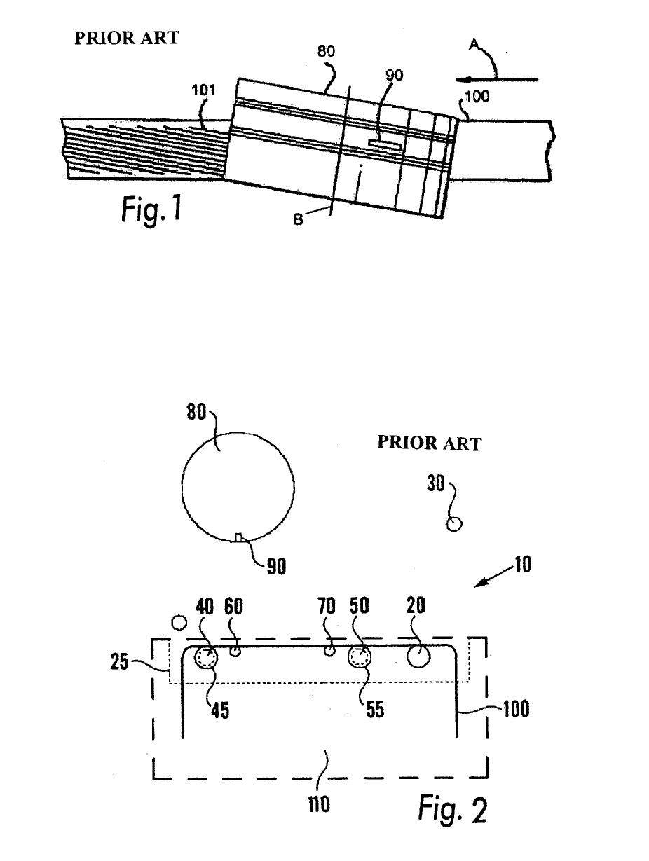

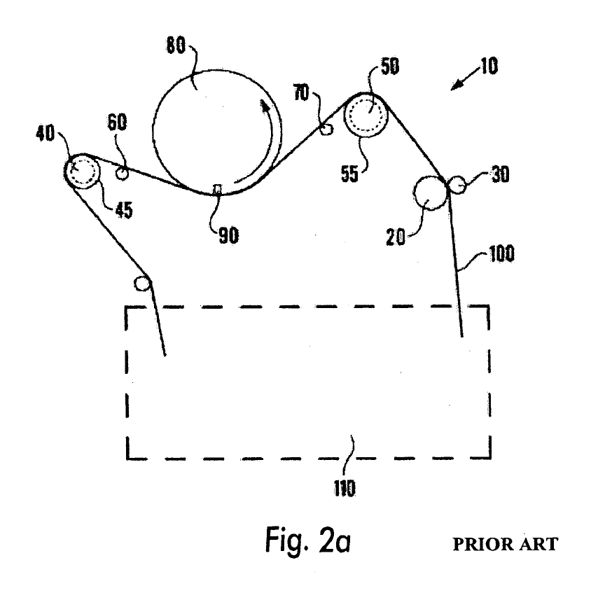

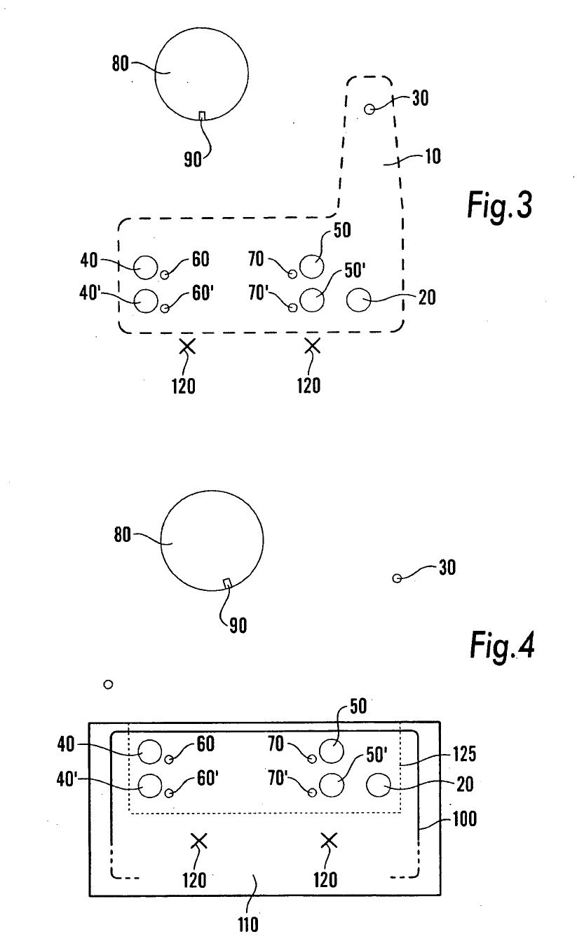

FIG. 3 is a schematic diagram of selected elements of a tape drive including a tape guide assembly 10 of one embodiment of the present disclosure. In the description that follows, parts similar to, or the same as, the parts described with reference to FIGS. 1 to 2b will be described using the same reference numerals.

Referring to FIG. 3, the tape guide assembly 10 includes a number of movable tape guides, including a pinch roller 20, a number of guide posts 40, 40′, 50, 50′ and a number of inclined posts 60, 60′, 70, 70′. The tape guide assembly 10 is fitted within a tape drive that includes a capstan 30, a rotary scan drum 80, a read and/or write head element 90, a tape drive mechanism 120 and a tape positioning arrangement (not shown) for positioning tape cartridges in the tape drive.

Referring to FIG. 4, during a loading operation, a tape cartridge 110 having a tape 100 of a first width is inserted into the tape drive. When a tape cartridge is inserted, the tape positioning arrangement positions the tape cartridge such that it is disposed in a predetermined position with respect to the tape drive mechanism 120 and the tape guide assembly 10. The pinch roller 20, guide posts 40, 40′, 50, 50′, and inclined posts 60, 60′, 70, 70′ (hereafter referred to as “tape guides”) protrude into a cavity (shown by dotted line 125) in the tape cartridge 110. This is the start, or non-deployed, position of the tape guides.

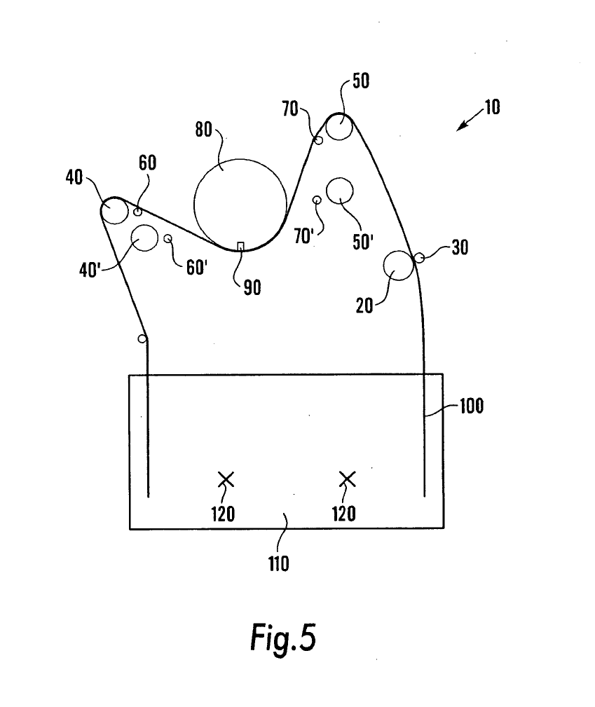

Referring to FIG. 5, in response to a tape deployment process being initiated, the tape guides are moved along respective predetermined tape guide paths in the tape drive to their finish, or deployed, positions. The respective paths cause, in most cases, the tape guides to move towards the drum 80. During that movement, a first subset of the tape guides (in this case guide posts 40, 50, inclined posts 60, 70 and pinch roller 20) engage the tape 100 and cause it to be deployed. As a result of the first subset of the tape guides reaching their respective predetermined deployed positions, at least a portion of the tape 100 is deployed around the drum 80 for reading/writing. It will be noted that the guide posts 40′ and 50′ and inclined posts 60′ and 70′ never actually engage the tape 100 when a tape of the first width is deployed.

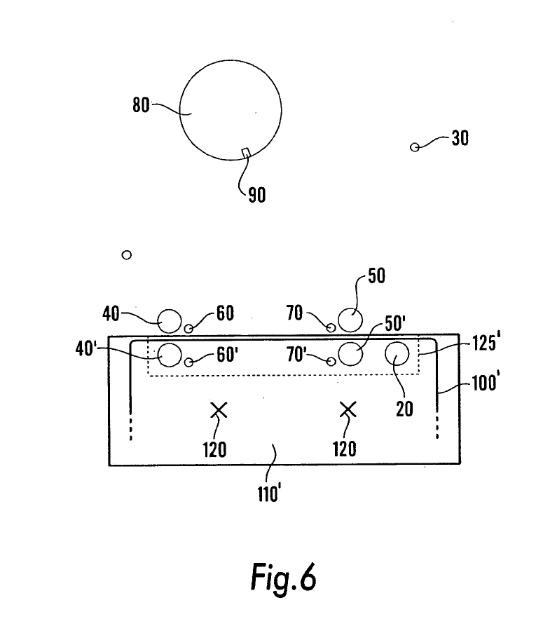

FIG. 6 is a schematic diagram of a tape cartridge 110′ having a tape 100′ of a second width inserted into the tape drive of FIG. 3. In this example, the second width is narrower than the first width. When the tape cartridge 110′ is inserted, the tape positioning arrangement positions the tape cartridge such that it is disposed in a predetermined position with respect to the tape drive mechanism 120 and the tape guide assembly 10. The pinch roller 20, guide posts 40′ and 50′ and inclined posts 60′ and 70′ protrude into a cavity (shown by dotted line 125′) in the tape cartridge 110′, whilst guide posts 40 and 50 and inclined posts 60 and 70 are outside in front of the tape cartridge 110′. The tape guides are in the same non-deployed positions as in FIG. 4.

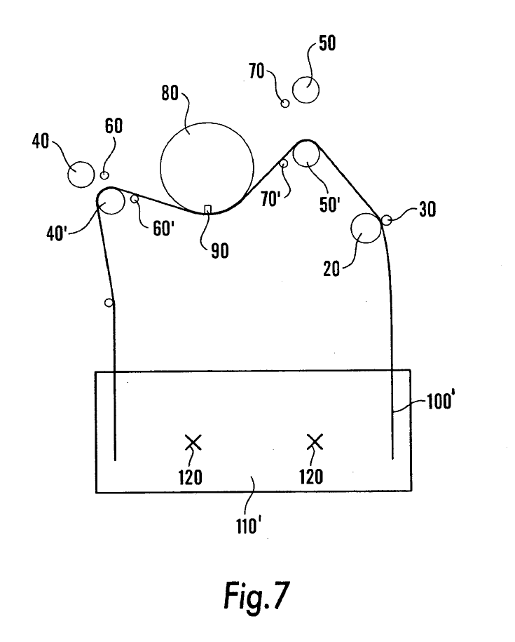

Referring to FIG. 7, in response to a tape deployment process being initiated, the tape guides are all moved along the same respective predetermined tape guide paths in the tape drive as has been discussed with reference to FIGS. 4 and 5. During this movement, a second subset of the tape guides (in this case guide posts 40′, 50′, inclined posts 60′, 70′ and pinch roller 20) engage the tape 100′ and cause it to be deployed. As a result of the tape guides reaching respective predetermined deployed positions, at least a portion of the tape 100′ is deployed around the drum 80 for reading/writing. It will be noted that guide posts 40 and 50 and inclined posts 60 and 70 do not engage, in some embodiments, the tape 100, when a tape 100′ of the second width is deployed.

As the guide posts 40 and 50 and inclined posts 60 and 70 only engage tapes of the first width and guide posts 40′ and 50′ and inclined posts 60′ and 70′ only engage tapes of the second width, the height of the guide posts and inclined posts can be selected at the manufacturing stage for compatibility with the width of the desired tape. In addition, flanges, such as the flanges 44, 45 shown in FIGS. 2 and 2a, can be used at the tops and bottoms of any or all of the guide posts to prevent lateral movement of the tape.

It will be appreciated that the pinch roller 20 is preferably able, in some embodiments, to engage across the full width of the widest tape that the tape drive is designed to receive. In one embodiment, that is the first width tape 100. So that the pinch roller will not clash with the tape cartridge 110′ for the second width tape 100′, the pinch roller is located at a lower level than the guide posts 40, 50 and the inclined posts 60, 70 such that it may only partially extend into the cavity 125′ and does not strike against the tape cartridge 110′. Suitable means are provided to raise the pinch roller 20 once it has moved upwardly to a level at which it can engage across the full width of the first width tape 100. Suitable means for moving the pinch roller 20 from its lower level location to the level at which it engages the first width tape are disclosed in United Kingdom Patent Applications Nos. 04 09668.1 and 04 09671.5, the content of which is incorporated by reference.

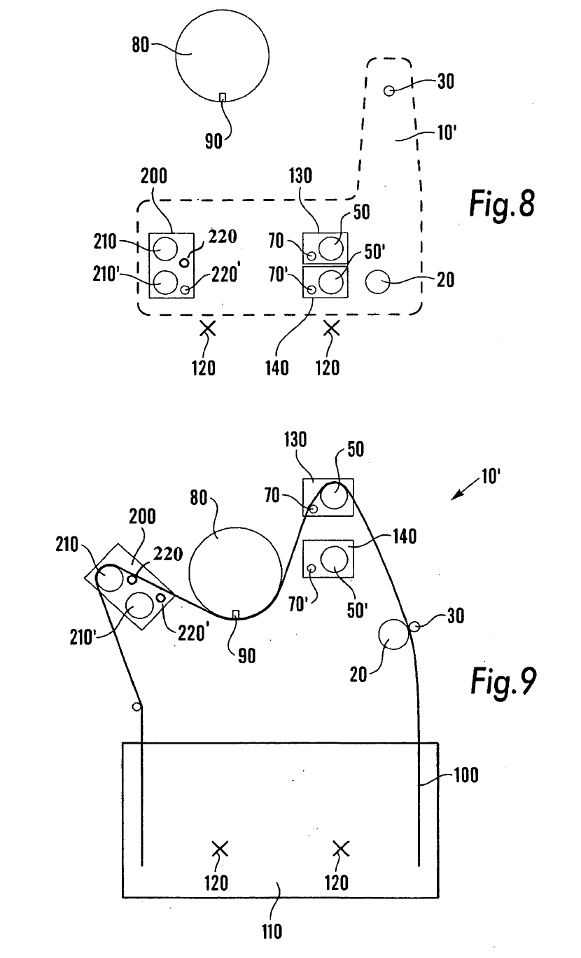

FIG. 8 is a schematic diagram of a tape guide assembly of one embodiment of the invention. This embodiment corresponds substantially to the embodiment of FIG. 3, with the exception that guide posts 40, 40′ and inclined posts 60, 60′ are replaced with a guide module 200 and the guide posts 50, 50′ are inclined posts 70, 70′ are similarly replaced by guide modules 130, 140.

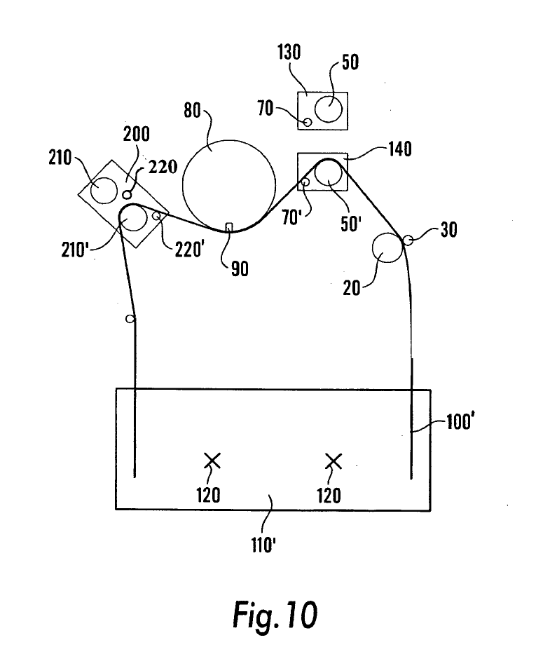

As shown in FIG. 11, the guide module 200 includes an outer guide post 210 having a height corresponding to the width of tape of the first width, an inner guide post 210′ having a height corresponding to the width of tape of the second width, and respective inclined posts 220, 220′. The outer guide post 210, inner guide post 210′, and inclined posts 220, 220′. are mounted on a common mounting member 214. During the tape deployment process, the guide module 200 is moved along a predetermined guide path from its non-deployed position (shown in FIG. 8) to its deployed position (shown in FIGS. 9 and 10). As in the first embodiment, the outer guide post 210 and the inclined post 220 are positioned to engage tape of the first width and the inner guide post 210′ and inclined post 220′ are positioned to engage tape of the second width, as can be seen from FIGS. 9 and 10.

In a similar fashion and as shown in FIGS. 8 to 10, the guide posts 50, 50′ and the respective inclined posts 70, 70′ are mounted on-respective common mounting members to define the guide modules 130, 140.

By replacing a number of tape guides with a single guide module, only a single element needs to be moved during the deployment process. In addition, selected parts of a guide module can be utilized in deploying more than one tape width and/or for different size tape cartridges. This advantageously reduces the number of components needed to move the guides that are in turn needed to support the various deployment paths, thereby reducing cost and complexity of the assembly.

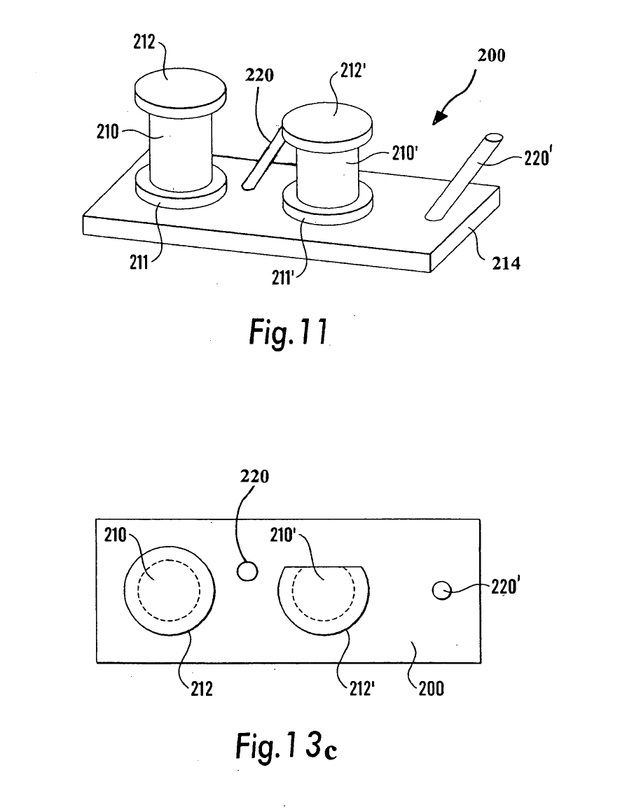

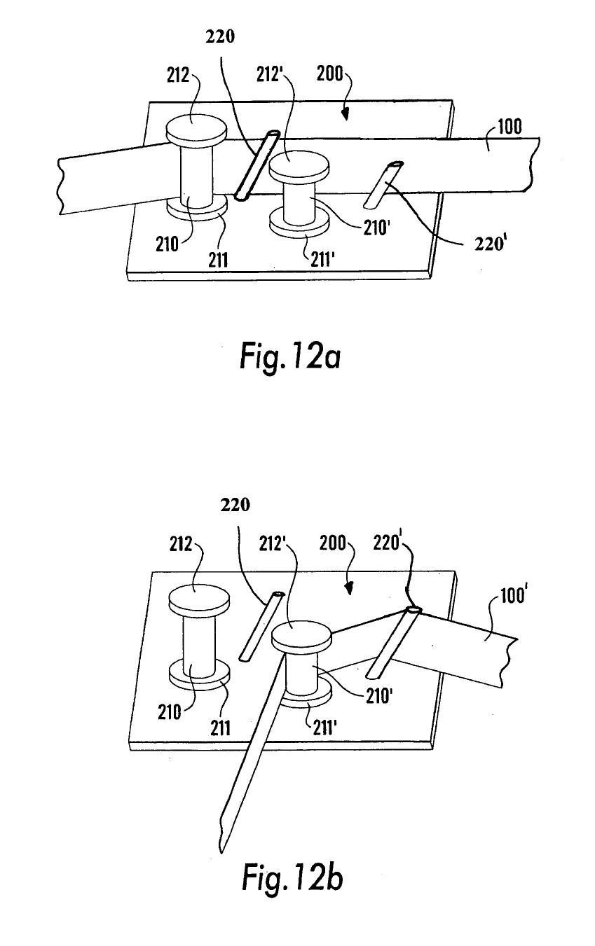

FIG. 12a shows the guide module 200 guiding a magnetic tape 100 having a first width. The tape 100 passes around the outer guide post 210 and inclined post 220. The inner guide post 210′ and inclined post 220′ are spaced from the tape. The outer post 210 has a height matched to the first width. Specifically, in that example, the outer guide post has a flange 211 at its end that is joined to the mounting member and a flange 212 at its free end. The flanges 211, 212 define a gap therebetween corresponding substantially to the first width.

FIG. 12b shows the guide module 200 guiding a magnetic tape 100′ having a second width, which is narrower than the first width. The tape 100′ passes around the inner guide post 210′ and inclined post 220′ and is spaced from the outer guide post 210 and inclined post 220. In the same way as the outer guide post 210, the inner guide post 210′ has flanges 211′,212′. The flanges 211′,212′ are arranged to define a gap therebetween corresponding substantially to the second width.

It is desirable to have the flanges 211, 212 and 211′, 212′ on the tops and bottoms of posts 210, 210′ to prevent lateral slippage of the tape as it is transported through the assembly 10 and across the head. This is particularly the case given the very limited margin for errors that the more advanced tape drives permit.

In the arrangement shown in FIGS. 12a and 12b, it will be apparent that if the inner post 210′ is not set back from the path followed by tape between the outer post 210 and inclined post 220, the tape may engage against the inner post 210′. In this scenario, the topmost flange 212′ could potentially rub against the surface of the tape and damage the tape.

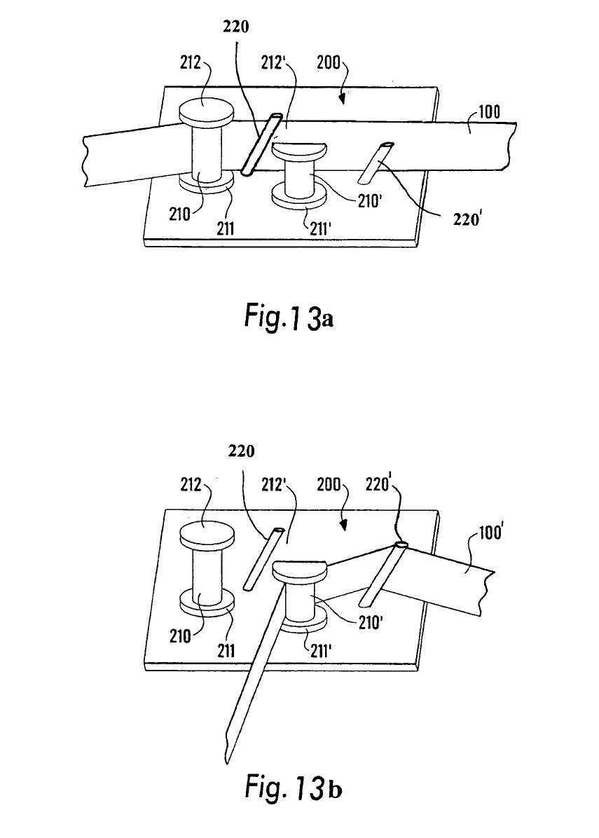

In another modification of the guide module 200 shown in FIGS. 13a, 13b and 13c, a portion of the flange 212′ is removed at positions at which the first width tape might otherwise contact the flange. This is best seen in FIG. 13c, where a portion of the flange 212′ is shown removed to define a flat surface. As illustrated by FIG. 13b, the flange 212′ is still able to provide adequate control of lateral movement of the narrower width magnetic tape 100′. However, when a first width tape 100 is being guided, the flat surface can provide auxiliary support for the tape and will not cause damage to the tape.

It will be appreciated that the first stage in deploying a portion of tape around a rotary scan head is the extraction of a portion of the tape from the tape cartridge. In some configurations, some of the guide posts, the pinch roller and/or the inclined posts may not play a part in the extraction of tape from a tape cartridge. Indeed, in many configurations, it is two or more guide posts that deal predominantly with the extraction. In such situations, the other guide posts, pinch roller, and/or inclined posts need not be positioned within a cavity of the tape cartridge in their non-deployed positions and could be positioned elsewhere in the tape drive and moved during the deployment process to engage the tape.

Although certain specific examples of tape guide assemblies have been described, it will be apparent that other configurations may be used. In particular, different numbers, and/or non-deployed, and/or deployed positions of guide posts, inclined posts, and pinch rollers (or indeed capstans) can be envisaged and will depend on factors including the type of tape to be written to or read from, the amount of tape that must be deployed around the rotary scan drum, and the amount of support it is desired to provide to the tape.

In the tape guide assembly shown in FIGS. 3 to 7, the tape guides are individual elements, whereas in the tape guide assembly shown in FIGS. 8 to 10, some tape guides are commonly mounted to define a guide module. It will be appreciated that various groupings of tape guides are possible, where the tape guides can be collectively moved to a deployed position as opposed to requiring individual movement of each element. The groupings selected are merely illustrative and will depend on whether the various elements intended to be grouped retain their relative proximity and positions when moved to their respective deployed positions. For example, it would not be possible to group guide posts 40 and 50 in the illustrated guide tape assemblies, as the distance between the posts in their non-deployed positions is greater than that in their deployed positions. Although the capstan has been illustrated as being fixed, it may be moveable during the tape deployment process.

Although the present disclosure has been discussed only in respect of two different tape widths, it will be apparent that the teachings of the present disclosure may be extended such that a greater number of tape widths can be accommodated. This could be achieved by providing additional tape guides for each additional tape width, all of the tape guides moving during loading to their deployed positions but only a respective subset actually engaging the tape.

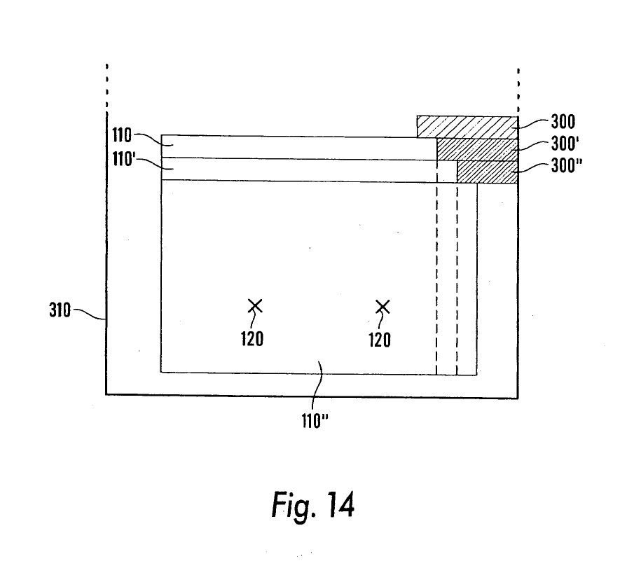

As previously described, so as to ensure correct location of each size of tape cartridge in the tape drive such that the correct subset of tape guides engage the tape, a tape cartridge positioning arrangement is used, in some embodiments. For example, successive abutments may be provided in the tape drive, in which case tape cartridges may be made of an appropriate size, and/or include appropriate indents, slots or the like, to allow insertion past the abutment. FIG. 14 is a schematic diagram of a tape cartridge positioning arrangement according to an embodiment of the present disclosure. The cartridge positioning arrangement may be used with any of the tape guide assemblies previously described. Referring to FIG. 15, a tape drive 310 includes drive means 120 and abutments 300, 300′ and 300″. A tape cartridge 110 of a first size is loaded until it reaches abutment 300. A tape cartridge 110′ of a second size is loaded until it reaches abutment 300′ and a tape cartridge 110″ of a third size is loaded until it reaches abutment 300″.

It will be appreciated that as viewed in FIGS. 5 and 6, each size of tape cartridge has a footprint defined by its length and width, the footprint of the tape cartridge shown in FIG. 6 being smaller than the footprint of the cartridge shown in FIG. 5. As shown in FIG. 6, the arrangement of the non-deployed tape guides 40, 50, 60, 70 which are intended to engage the wider tape shown in FIG. 5 is such that when a smaller cartridge having a narrower tape is inserted into the tape drive, those tape guides are disposed outside the footprint of the smaller tape cartridge.

It should be emphasized that the above-described embodiments of the present disclosure, are merely possible examples of implementations, merely set forth for a clear understanding of the principles of the disclosure. Many variations and modifications may be made to the above-described embodiment(s)without departing substantially from the spirit and principles of the present disclosure. All such modifications and variations are intended to be included herein within the scope of this disclosure and protected by the following claims.

Therefore, having thus described the present disclosure, at least the following is claimed:

1. A tape deployment system for deploying magnetic tape from multiple size tape cartridges around a drum of a rotary scan data transfer apparatus, each size tape cartridge of said multiple size tape cartridges holding a magnetic tape having a width different to the width of other sized tapes of said multiple size tape cartridges, the tape deployment system comprising:
a tape guide assembly comprising a plurality of tape guides each movable during a tape deployment process between a respective non-deployed position and a respective deployed position, said tape guides being arranged such that during said tape deployment process all move from their non-deployed to their deployed position; and
a tape cartridge positioning arrangement arranged to locate each size of tape cartridge of the multiple size tape cartridges in a predetermined position relative to said non-deployed position of said plurality of tape guides such that during a said deployment process, when all of the plurality of tape guides move from their non-deployed position to their deployed position, a predetermined subset of the plurality of tape guides engages the magnetic tape of the cartridge, the tape guides of the predetermined subset having heights not substantially greater than the width of the magnetic tape of the respective tape cartridge.

2. A system as claimed in claim 1, wherein said plurality of tape guides comprises at least one guide post and at least one inclined post.

3. A system as claimed in claim 1, wherein said plurality of tape guides comprises at least one guide module comprising at least one guide post and at least one inclined post mounted on a single mounting member.

4. A system as claimed in claim 3, wherein said at least one guide module comprises a guide module having a plurality of guide posts of different height and respective inclined posts associated with said guide posts.

5. A system as claimed in claim 1, wherein said plurality of tape guides comprises a pinch roller.

6. A system as claimed in claim 1, wherein each said subset comprises a plurality of said tape guides, each having a height corresponding substantially to the width of the magnetic tape of the respective tape cartridge.

7. A system as claimed in claim 1, wherein said multiple size tape cartridges comprise a first size tape cartridge holding a magnetic tape having a first width and a second size tape cartridge, said second size tape cartridge holding a magnetic tape having a second width, which second width is smaller than said first width, and being smaller than said first size tape cartridge, said tape guide arrangement being arranged to locate said first size cartridge at a first said predetermined location and to locate said second size cartridge at a second said predetermined location, said plurality of tape guides comprising a first said subset of tape guides and a second said subset of tape guides, said first and second subsets of tape guides being arranged such that in their respective non-deployed positions, the tape guides of the first subset are disposed externally of a footprint of said second size tape cartridge when located at said second predetermined location and the tape guides of said second subset are disposed at least partially internally of said second size tape cartridge.

8. A system as claimed in claim 7, wherein said first and second subsets are arranged such that when a said first size tape cartridge is located at said first predetermined location, the tape guides of said first and second subsets are disposed internally of a footprint of said first size tape cartridge.

9. A system as claimed in claim 7, wherein said tape guides of said second subset disposed internally of said footprint of the second size cartridge are received in a cavity defined by said second size tape cartridge.

10. A system as claimed in claim 8, wherein said tape guides of said first and second subsets disposed internally of said footprint of the first size cartridge are received in a cavity defined by said first size cartridge.

11. A system as claimed in claim 1, wherein each tape guide of each subset has a height corresponding substantially to the width of the magnetic tape of the respective magnetic tape cartridge.

12. A system as claimed in claim 1, wherein said tape cartridge positioning arrangement comprises respective abutments defining the said predetermined locations of said multiple size tape cartridges.

13. A digital data transfer apparatus comprising a tape deployment system as claimed in claim 1.

14. A tape deployment system for deploying magnetic tape from multiple size tape cartridges around a drum of a rotary scan data transfer apparatus, each size tape cartridge of said multiple size tape cartridges holding a magnetic tape having a width different to the width of the magnetic tapes of the other size cartridges of said multiple size tape cartridges, the system comprising:
tape deployment means for deploying the different width tapes from the multiple size tape cartridges, said tape deployment means comprising a plurality of tape guide means each having a height, a non-deployed position, and a deployed position and being arranged such that all move from their non-deployed position to their deployed position during a tape deployment process; and
tape cartridge positioning means for positioning each of the multiple size tape cartridges in a predetermined position with respect to the tape guide means such that when all of the tape guide means move from their non-deployed position to their deployed position during a said deployment process, only a predetermined subset of said tape guide means from a plurality of subsets of tape guide means defined by said plurality of tape guide means engages the tape, each said subset of tape guide means comprising at least one tape guide having a height substantially corresponding to the width of the magnetic tape of the respective magnetic cartridge.

15. A system as claimed in claim 14, wherein each size cartridge of said multiple size cartridges defines a footprint and said tape cartridge positioning means is arranged to locate said multiple size tape cartridges in said predetermined locations such that any said subset of tape guide means comprising a tape guide having a height substantially greater than the width of the respective tape cartridge is disposed externally of the respective footprint of the cartridge.

16. A system as claimed in claim 15, wherein any said subset of tape guide means not disposed externally of said footprint is arranged to be received in a cavity defined by the respective tape cartridges.

17. A system as claimed in claim 14, wherein each said subset of tape guide means comprises at least one tape guide means comprising a post having a flange at a free end thereof for guiding an edge of the respective magnetic tape.

18. A system as claimed in claim 14, wherein at least one said subset of tape guide means comprises at least one tape guide unit comprising a plurality of said tape guide means mounted on a common mounting.

19. A digital data transfer apparatus comprising a tape deployment system as claimed in claim 14.

20. A tape deployment system for deploying magnetic tape from a first sized magnetic tape cartridge and a second sized tape cartridge around a drum of a rotary scan data transfer apparatus, said first sized magnetic tape cartridge having a length and a width defining a first footprint and holding a magnetic tape having a first width and said second sized tape cartridge having a length and a width defining a second footprint smaller than said first footprint and holding a magnetic tape having a second width which is less than said first width, each said magnetic tape having a drum engaging an outer side and a non-engaging inner side, said tape deployment system comprising:
a tape guide assembly comprising a plurality of tape guides positioned for selectively engaging said inner side of said magnetic tapes, said plurality of tape guides comprising first tape guides having a height substantially greater than said second width and second tape guides having a height not substantially greater than said second width, each of said first and second tape guides being movable between a respective non-deployed position and a respective deployed position and said first and second tape guides being arranged such that during a tape deployment process all move from their non-deployed position to their deployed position; and
a tape cartridge positioning structure that defines a first predetermined location to which said first sized cartridges can be inserted and a second predetermined location to which said second sized cartridges can be inserted, said first predetermined location being located such that when a first sized tape cartridge is located at said first predetermined location with said first and second tape guides in their respective non-deployed positions, the first tape guides are within said first footprint facing said inner side of the first width tape and said second predetermined location being located such that when a second sized tape cartridge is located at said second predetermined location with said first and second tape guides in their respective non-deployed positions, the first tape guides are disposed externally of said second footprint facing said outer side of the second width tape and said second tape guides are within said second footprint facing said inner side of the second width tape.

21. A system as claimed in claim 20, wherein said tape cartridge positioning structure comprises respective abutments defining said first and second predetermined locations.

22. A system as claimed in claim 20, wherein when said first tape guides are located within said first footprint, said first tape guides are received in a cavity defined by the first sized tape cartridge.

23. A system as claimed in claim 20, wherein when said second tape guides are located within said second footprint, said second tape guides are received in a cavity defined by said second sized cartridge.

24. A digital data transfer apparatus comprising a tape deployment system as claimed in claim 20.

25. A tape cartridge format for use in a rotary scan data transfer apparatus having a plurality of tape guides for deploying and supporting tape for reading and writing by the data transfer apparatus, the format including a plurality of tape cartridge sizes, each cartridge size holding a predetermined length of tape of a predetermined width different to the width of tape of the other size cartridges, each tape cartridge of one of the plurality of sizes being locatable in a different predetermined position in the tape drive with respect to respective non-deployed positions of the tape guides such that during deployment and support of the tape, only a subset of the tape guides corresponding to the width of the tape of that tape cartridge size engage with the tape held by the tape cartridge.
